(19) United States
(12) Patent Application Publication
(10) Pub. No.: US 2023/0198773 A1
(43) Pub. Date: Jun. 22, 2023

(54) VOTING USING CHOICE COIN ON A BLOCKCHAIN

(71) Applicant: FORTIOR BLOCKCHAIN, LLLP, Sheridan, WY (US)

(72) Inventors: Brian Haney, Bellevue, WA (US); Archie Chaudhury, Peachtree City, GA (US)

(21) Appl. No.: 17/559,519

(22) Filed: Dec. 22, 2021

(51) Int. Cl. H04L 9/32; G06N 10/80

(52) U.S. Cl. CPC H04L 9/3239; H04L 9/3218; G06N 10/80; H04L 2209/463

(57) ABSTRACT

The disclosure is a device and methods for decentralized voting. Embodiments of the disclosure are comprised of three steps. First, users in a decentralized network access the Algorand blockchain via a secure decentralized application (dApp). Second, the users cast a vote by sending one Choice Coin asset to an address associated with a vote. Third, an artificial intelligence program iterates over the data, calculating the total votes and recording the results.

### BACKGROUND TO THE INVENTION

The field of the invention rests at the intersection of three broader fields, voting, artificial intelligence and blockchain. Voting is a method by which collective information is processed to determine consensus. Artificial intelligence is a computer program replicating the thoughtful processes of the human mind. Blockchains are decentralized databases, maintained by distributed networks of computers. Converging these three fields, the invention relates to software for blockchain voting using artificial intelligence.

More than a century ago, Thomas Edison's first invention was an electric voting machine. Despite the technical innovations of the last 150 years, still many political elections rely on punch hole or handwritten ballots to carry out elections. Handwritten and punch hole ballots are particularly vulnerable to voting fraud and counting errors because such ballots are often difficult to read or ascertain the choice made by the voter. The present disclosure provides a technically superior alternative to current voting methods by leveraging the security and scalability of the Algorand blockchain.

A consensus is a majority or agreement, which may be reached via vote. Voting happens across industry—in corporate shareholder meetings and political elections. In fact, voting is important because the right to vote is the central tenant of modern democracy, but also because it is a principle means for business practice. The integrity of voting systems is critical to modern political societies and economic markets.

A Decentralized Autonomous Organization (DAO) is a blockchain based network of independent contractors, developers, and entrepreneurs. DAOs operate collaboratively without the need for formal incorporation, however in some states such as Wyoming, DAOs are legally recognized like an LLC or partnership for corporate purposes. Moving forward, DAOs continue to be more prevalent growing in size and number across the Internet in the growing decentralized ecosystem. In many ways, DAOs create opportunity and spawn entrepreneurial activity across the Internet.

In the world of cryptocurrency transfers, the Decentralized Voting Problem requires formulating a way for participants to reach a consensus on how to distribute value without external interference or governance. For example, if an organization operating under a decentralized system needs a specific way to determine a governance change, the organization will use voting among certain members within the network to reach a decision. Defined, the decentralized voting problem is how to create a system where people can vote with weight associated value metrics? To answer these questions, the present disclosure borrows elements across the technical spectrum, appreciating a confluence of computational architecture to focus narrowly on security and scalability features.

The term artificial intelligence (AI) has been discussed at length by various scholars and industry leaders. Generally, AI refers to any machine capable of learning, remembering, and taking actions. AI technology is affecting industries across the economy including law, healthcare, and defense. AI automates tasks that were previously done manually, thus digitizing work and improving efficiency. For example, in the legal industry, technology assisted review is changing the discovery process. In other words, AI programs now complete tasks previously only lawyers could do, like classify documents based on relevancy during discovery according to evidentiary rules.

Broadly, AI is a field uniquely positioned at the intersection of several scientific disciplines including computer science, applied mathematics, and neuroscience. The AI design process is meticulous, deliberate, and time-consuming—involving intensive mathematical theory, data processing, and computer programming. All the while, AI's economic value is accelerating. One example of AI is deep learning, a process is inspired by the neurological structures found in the human brain. Both artificial and biological neurons receive input from various sources and map input information to a single output value. Artificial neurons model the strength of synapses, the connectivity between neurons, with weight coefficients. Thus, neural information transfer in the biological brain inspires the way in which modern neural networks operate. At the confluence of AI and blockchain technologies, great opportunity for innovation is available.

Another example of AI technology is reinforcement learning. Reinforcement learning algorithms contain three elements: (1) model: the description of the agent-environment relationship; (2) reward: the agent's goal; and (3) policy: the way in which the agent takes actions. For reinforcement learning systems, the environment represents the problem. Formally, reinforcement learning is often described through an agent-environment interaction, with the Markov Decision Process. The integration of reinforcement learning systems with deep learning technologies is an edge area in software innovation—where applications on quantum hardware push technical progress.

As an architecture, a blockchain is a distributed ledger which records transactions between parties. In other words, blockchain technology is both an infrastructure for data storage and management. From a computational perspective, the programming language C++ was originally the most commonly used for blockchain software development. However, other languages are used in development, for example both Python and C support blockchain construction, with Python becoming far more frequently used. The structure for the blockchain may be considered to have four parts: the network, the public-private key system, the transactional process, and mining. However, mining is not always an element for blockchains, particularly in proof-of-stake blockchains, such as Algorand which do not use mining.

The blockchain network consists of several computers, called nodes connected via the Internet. Each node maintains a transaction record called a ledger, which acts as a parasitic function of the Internet. The internet has two fundamental layers, the Transmission Control Protocol (TCP), which manages packet assembly, and the Internet Protocol (IP) which passes packets from one computer to another. Blockchain networks like Bitcoin, Ethereum, and Algorand ultimately rely on TCP and IP to operate and can be viewed as application protocols, sitting on top of the transport layer.

The peer-to-peer network developed to solve the double spending problem, where the same digital coin is spent more than once. For example, the blockchain protocol uses timestamps and a proof-of-work to record a public history of transactions. The timestamp captures the time of transactions on the network, while the proof-of-work validates transactions. The idea is nodes consider the longest chain to be the correct one and will continue working to extend it. In other words, nodes validate the longest chain, which is the only chain that will continue to be extended. The means by which nodes transact is through a system of Public-Private Key Cryptography.

In short, PPKC enables encrypted messages to be sent without the need for a shared key. For example, one of the first PPKC systems was the Rivest-Shamir-Adleman (RSA) algorithm. The RSA algorithm creates a mathematically linked key pair by multiplying two prime numbers together. While, multiplying two prime numbers is computationally inexpensive, figuring out which prime numbers were multiplied to get a number is computationally complex, making it possible to broadcast a public key while reserving a secure private key.

Other security mechanisms on blockchains utilize the SHA-256 hash algorithm. The SHA-256 algorithm is the foundation of blockchain mining. The SHA-256 is a one-way hash function, which processes any message of an arbitrary size into a condensed representation called a message digest. Presently, most believe there is no efficient algorithm, which can invert SHA-256. As a result, the only way to solve the SHA-256 is brute force search, trying different inputs until a satisfactory solution is found. Thus, the product of meticulous math, the SHA-256 is used commonly across industry in cybersecurity.

SHA-256 uses a sequence of sixty-four constant 32-bit words, K₀^{{256}}, K₁^{{256}}, . . . , K₆₃^{{256}}, representing the first thirty-two bits on the fractional parts of the cube roots of the first sixty-four prime numbers. Thus, SHA-256 uses six logical functions, where each function operates on 32-bit words, which are represented as x, y, and z. The SHA-256 is described in two stages, preprocessing and hash computation. However, in certain embodiments, the SHA-512 which is a post-quantum derivative of the SHA-256 and more secure, may be utilized in the present invention to secure user or voter information. The SHA-512 hash algorithm is used in certain embodiments to securely store and process voter and user data.

In a blockchain, the transactions are bundled into blocks. A block is a data structure, aggregating transactions for inclusion in a public ledger. Each block consists of a hash value from the previous block, which are transactions happening in the last ten minutes, and a random integer called a nonce. Each block is broadcast to the network, presenting a complex algorithmic problem for validation. Solving blocks typically requires an enormous amount of computation, but verifying the solution is relatively simple. As such, graphics processing units are the most popular hardware tool for blockchain technologies.

A transaction communicates to a network an authorized information movement has occurred. The essential elements are a network of parties, an asset moved among those parties, and a process defining the procedures and obligations associated with the movement. In other words, transactions are data structures encoding the value transfer between participants in a system. While costly financial institutions have policed such transactions in the past, blockchain supports a network of traders to perform this function itself. As such, one of the most interesting aspects of blockchain technology is that a central authority does not need to verify transactions.

Algorand is a proof-of-stake blockchain, which evolved to improve security and power efficiency across the blockchain networks by limiting miners to validating transactions proportional to an ownership share. One problem Algorand solves is the majority override, a cryptographic hack which results from a competitive advantage in mining where one actor can control a majority of the nodes with more computing power. To combat the majority override problem, Algorand developed a proof-of-stake chain, differing from classical blockchains, which use a proof-of-work to validate transactions. Algorand also provides a democratic consensus mechanism for voting among nodes in its network.

Algorand is the most technically advanced and sophisticated blockchain technology, utilizing advanced post-quantum cryptographic mechanisms and zero-knowledge proofs (ZKPs) for everyday transactions across its peer-to-peer network. By maintaining a record of all transactions, the peer-to-peer network ensures all transactions are validated based on upon the record of previous transactions. On Algorand, transactions are data structures encoding the transfer of value between participants in a system using ZKPs. A key innovation for the Algorand blockchain is that transaction fees are de minimis, <$0.01 per transaction. The low transaction fees are possible because Algorand uses a proof-of-stake mechanism to validate blocks and process smart contracts. Moreover, the low transaction fees on the Algorand blockchain create a unique opportunity for scalable growth in non-financial related blockchain technologies, such as voting.

The primary means by which applications are deployed on Algorand is smart contracts. A smart contract is a computer program which automatically executes, transferring cryptocurrency. In other words, smart contracts are programs that are logically executed on a blockchain without a central oversight. Smart contract technology finds itself drawing on principles of law, finance, and technology to create new type of machine all together. Previously, contracts were only written in human language, rather than live and changing computational systems. Algorand Smart Contracts (ASCs) are programs for blockchain transactions on the Algorand network. Traditionally, ASCs are separated into two main categories, stateful and stateless.

Stateless smart contracts are primarily used for signature authorities but can also validate transactions. In other words, Stateless Smart Contracts are essentially escrow functions. An escrow is a contractual arrangement in which a third party receives and disburses money or property for transacting parties. Usually, contractual performance depends on conditions agreed to by the transacting parties. They validate transactions between two parties, replacing traditional escrow accounts. Stateless smart contracts on the Algorand Network also act as signature delegators, signing transactions, thus validating them on the main blockchain network.

Stateful smart contracts are the Algorand Network's backbone. The term stateful refers to the contract's ability to store information in a specific state on the network. For example, one type of stateful smart contract is an opt-in contract, allowing the user to elect to receive certain assets. The stateful opt-in contract stores data on the Network, associating the receiving account and the specified asset. Stateful smart contracts can be combined with all the other features to produce even more complex application types. Stateful smart contracts are used for data storage, both global or local, and functional processing on the Algorand blockchain. For example, a stateful smart contract may be used as a voting method, storing data globally based on the result of several votes. However, to allow for a complete voting system at scale, both stateless and stateful smart contracts must be used.

Algogeneous smart contracts allow multiple tasks to be efficiently integrated within one intelligent function, all on the Algorand blockchain. A smart contract by itself is a payment function, including functionality that both stores information and validates a transaction. Algorand's smart contracts can be linked through a reference pattern in which one smart contract's output can be dependent on another smart contract's logic. In short, an Algogeneous Smart Contract is a smart contract that manages to achieve the functionality of both a stateless and stateful smart contract in a singular system.

The problem in current voting systems is that they lack scalability and security. As a result, voting is often tampered with for purposes of political elections. Therefore, there exists a need for a new type of scalable and secure voting protocol. The present discloser meets this need, by introducing a device and methods for scalable and secure voting.

### SUMMARY OF THE INVENTION

The disclosure is a device and methods for decentralized voting, which in certain embodiments may be described in three steps. First, voters access the Algorand blockchain through a secure decentralized application (dApp). Second, the vote cast a vote by sending one Choice asset to the address associated with their vote. Third, an artificial intelligence program iterates over the data, calculating the total votes, recording the results, and rewarding the voters.

This invention solves two problems. The first problem this invention solves is how to create a scalable voting system for wide ranging and global populations. The second problem this invention solves is how to secure voting technology at scale. The main advantages of the present disclosure compared to current voting technology are security and scalability.

### BRIEF DESCRIPTION OF THE DRAWINGS

FIG. 1 describes embodiments of the present invention as an information flow model including a voter voting through a quantum secure voting interface where voting information is sent to and aggregated on the Algorand blockchain.

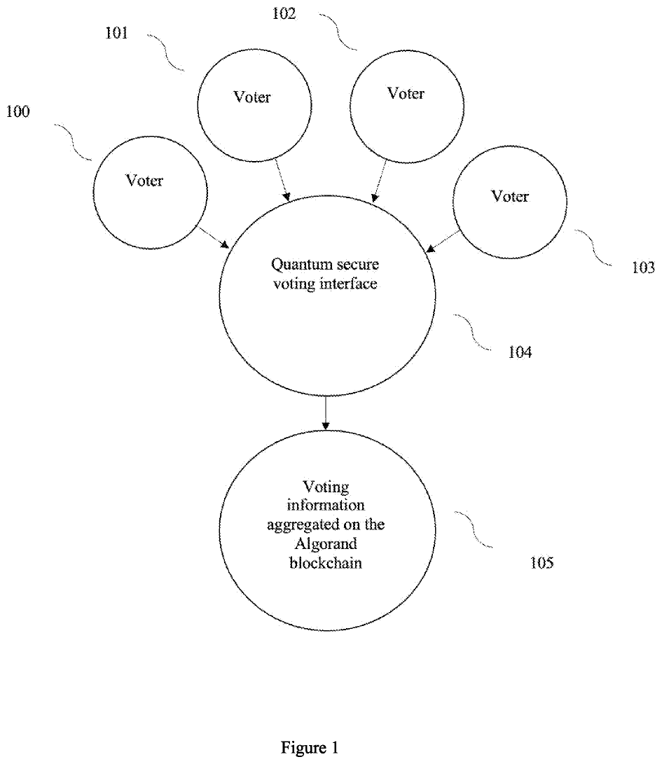

FIG. 2 describes embodiments of the present invention as an information flow model including a voting population providing user information including votes, where the data is transmitted to the blockchain and encrypted as a post-quantum hash.

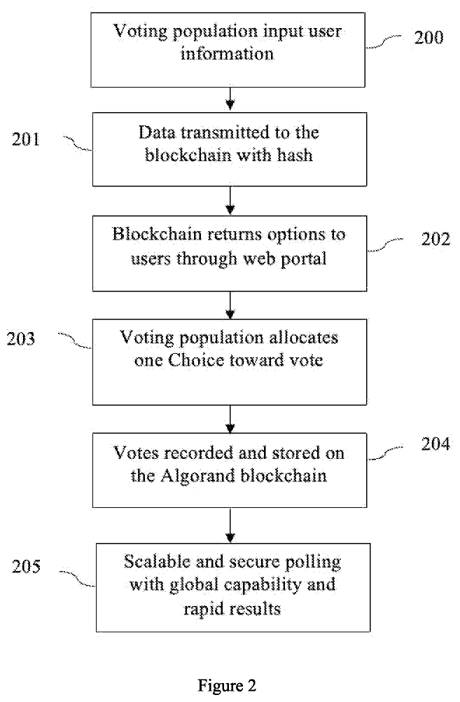

FIG. 3 describes embodiments of the present invention as an information flow model including a user accessing a secure voting interface, where the interface presents voters with options to vote on.

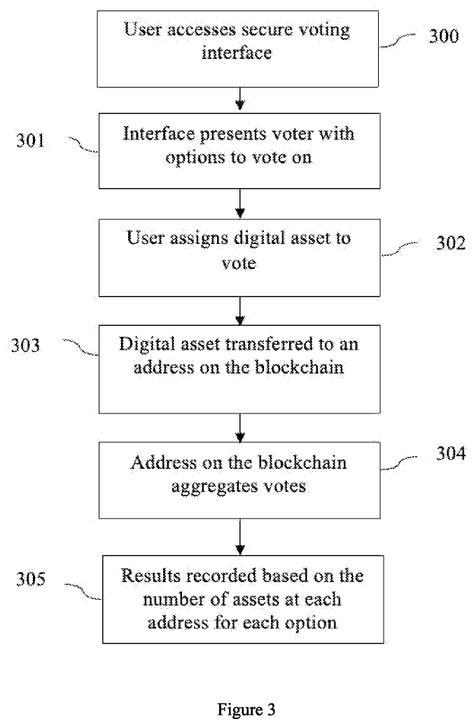

FIG. 4 describes embodiments of the present invention as an information flow model including a voter providing voting information.

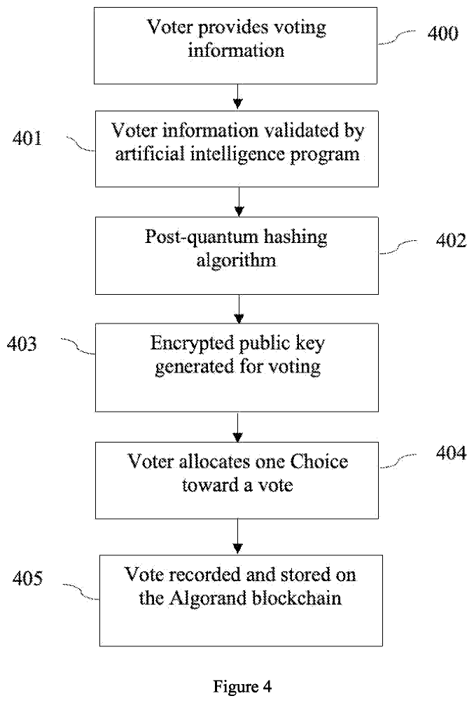

FIG. 5 describes embodiments of the present invention as an information flow model including a Voter connects Algorand wallet to voting dApp, where a voter pushes vote button and one Choice sent to address associated with voter selection.

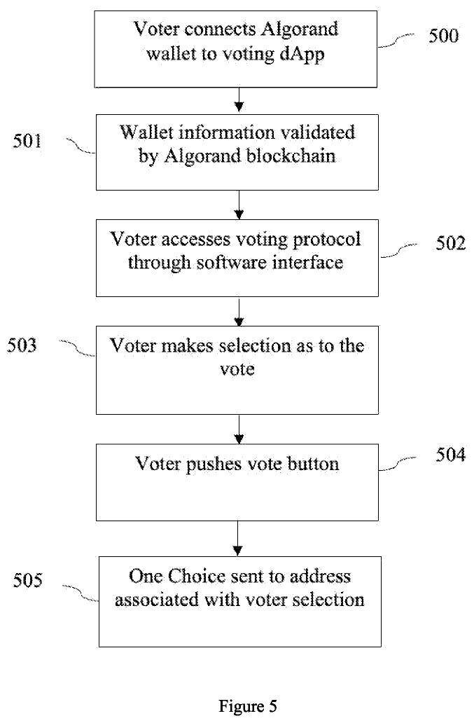

### DETAILED DESCRIPTION OF THE INVENTION

In certain embodiments, embodiments of the present disclosure voters 100-103 vote. The voting happens through a quantum secure voting interface 104 where voting information is sent to and aggregated on the Algorand blockchain 105. The number of voters 100-103 may scale to meet the specific needs of a given poll without sacrificing security.

In certain embodiments, embodiments of the present disclosure, a voting population provides user information including votes 200, where the data is transmitted to the blockchain 201 and encrypted as a post-quantum hash. Then, the blockchain returns options to users through web portal 202 and the voters of the population allocate one Choice toward vote 203. Then, the votes are recorded and stored on the Algorand blockchain 204 providing a scalable and secure polling with global capability and rapid results 205.

In certain embodiments, embodiments of the present disclosure, a user accesses a secure voting interface 300, where the interface presents voters with options to vote on 301. Then, the user assigns digital assets to vote 302, such as Choice, and the digital asset is transferred to an address on the blockchain 303. Finally, the address on the blockchain aggregates votes 304 and the results are recorded based on the number of assets at each address for each option 305.

In certain embodiments, the present disclosure describes embodiments of the present invention as an information flow model including a voter providing voting information 400. The voting information is then validated by artificial intelligence program 401 and processed by a post-quantum hashing algorithm 402, generating an encrypted public key generated for voting 403. The voter then allocates one Choice toward vote 404 and the vote recorded and stored on the Algorand blockchain 405.

In certain embodiments, describes embodiments of the present disclosure as an information flow model including a Voter connects Algorand wallet to voting dApp 500. The wallet information validated is by Algorand blockchain 501. The voter accesses voting protocol through software interface 502 and the voter makes selection as to the vote 503. Finally, the voter pushes vote button 504 and one Choice sent to address associated with voter selection 505.

In certain embodiments, the voting happens using Algogeneous smart contracts, which integrate stateless and stateful smart contracts to scalably deploy a decentralized voting machine. Each individual vote is stored on the blockchain as a stateful smart contract, and a stateless smart contract validates votes among a population or organization. In other words, the stateful smart contracts allocate votes and the stateless smart contracts approve the votes, aggregating them in a singular location on the blockchain. The validation mechanism may be used to add legitimacy to voting process and prevent fraud, as well as suppression by ensuring all votes are counted, open, and secure, without reveal any individual voter identity.

In certain embodiments, stateful smart contracts control the logic for blockchain voting. The term stateful refers to the contract's ability to store information in a specific state on the network. Stateful smart contracts are contracts that live on the chain and are used to store data, such as votes for particular voters. The stateful contract stores voting data on the Algorand network by associating the receiving account and the specified vote in blockchain storage.

In certain embodiments, Algogeneous smart contracts integrate both stateless smart contract and stateful smart contract functionality into a singular smart contract, which may be deployable in a single script executable. Algogeneous smart contracts may be deployed from a command line interface, using various computer software languages such as C++, Python, Teal, or Solidity. One advantage for using heterogeneous smart contracts in the voting process is the simplicity with which the software may deployed, adding scalability to the process for decentralized decisions.

In certain embodiments, various forms of AI may be integrated within an Algogeneous smart contract, stateful smart contract, or stateless smart contract to process votes. Broadly, and as used herein, AI refers to any computer program replicating the thoughtful processes associated the human mind. Certain types of AI used in various embodiments of the present invention include machine learning, neural networks, embedded intelligence. Machine learning is a process by which programs improve over time and through experience. Neural networks are used for machine learning using matrix multiplication and derivate calculations to learn from data over time. Embedded intelligence is a type of AI that utilizes human knowledge captured in a formal software architecture for decision making.

In certain embodiments the invention utilizes the Choice Voting Protocol, a simplified voting process designed toward perfecting efficiency. The Protocol may allow organizations to assign votes to participants and governments to assign votes to populations. Voting processes using Choice Coin, a governance token, and the Choice Coin protocol may be open or closed to the members of a particular organization. The decisions or proposals will each have dedicated addresses on the Algorand blockchain with constituent addresses compiling the votes. For example, Votes may be tabulated through stateless smart contracts that send one Choice, the Choice Coin unit, to an address for the decision. Throughout the streamlined process the administrator may stop counting at any time to tabulate the results. The results are computed through a stateful smart contract counting the number of votes.

In certain embodiments, the voting software emphasizes the allocation of proper weight given in decision-making processes. Specifically, an embedded intelligence computer program enters parameters into the stateless smart contract upon successful validation of the voter's identity using a secure key. In such embodiments, the specific parameter is the stake, which is both recorded in the database and entered by the voter for validation. The stateless smart contract then sends a certain number of assets to a decision address, which uses an Algogeneous smart contract to aggregate votes and record results. Choice Coin and the Decentralized Decisions software help advance democratic decision making in groups, organizations, and governments.

In certain embodiments, the invention is methodologies for a new type of voting, which may incorporate the laws of quantum mechanics to create an optimized voting machine on blockchain networks. The methodologies described are dedicated toward blockchain development and focused on voting with associated rights in corporate governance and scalable security for political voting. In short, the solution to the Decentralized Voting Problem is a weighted and generalizable quantum voting algorithm.

In certain embodiments, the main programming language used for the present disclosure is Python. Python is general purpose and interpreted programming language. There are two main mechanisms by which Python code is written and deployed, PyTeal and the Algorand Python-SDK. PyTeal is a Python compiler for Algorand's Transaction Execution Approval Language (TEAL), a logical language for smart contracts. The Algorand Python-SDK is Python library for interacting with the Algorand network.

In certain embodiments, the front-end interface for the Decentralized Decisions software is developed using Flask. Flask allows developers to have independence with regards to the backend packages they may want to use within Python's ecosystem. Flask is designed for web-development and allows developers to render HTML files directly through a Python backend. Specifically, Flask is a Web Server Gateway Interface (WSGI) framework. As a result, Flask communicates effectively between the user and the Algorand blockchain with a Python backend.

In certain embodiments, the main programming language used for the present disclosure is the JavaScript programming language. In such embodiments, the Algorand JavaScript-SDK codifies the voting logic. JavaScript is a high-level compiled programming language, which is often used for both backend and frontend web-development. In certain embodiments, the present disclosure is programmed entirely in the JavaScript programming language to directly deliver a vote to users through a secure interface with Algorand wallet connect capability.

In certain embodiments, various public addresses will be used to compile the votes together. The votes themselves may be tabulated through stateless smart contracts that send one Choice, or a Choice Coin derivative unit, to a smart contract. The process in such embodiments is efficient; where a semi-autonomous computer program stops at a defined time to tabulate the results. The results may be computed through a stateful smart contract on the Algorand blockchain that counts the number of votes, or the amount of Choice that each address has.

In certain embodiments, votes are recorded on the Algorand blockchain and are made available through the Algo Explorer, a user web interface for the Algorand blockchain. The Algo Explorer only records the public Algorand Address of the voter, ensuring that an individual voter's privacy and identity are kept private. In such embodiments, this may be done by hashing the required voter data into hexadecimal form through a SHA-512 protocol. SHA-512 is also a post-quantum cryptography protocol, ensuring that its collision-resistant property holds even when put up against a quantum computer. This ensures that private information is not leaked to malicious attackers. It is also an improvement over current systems, where voting records and other information are often made public without the consent of participants.

In certain embodiments, the present disclosure may be used for control of a DAO. A voting software may be used to vote on proposals or changes to the DAOs software or other technical infrastructure. Additionally, the present disclosure may be used to vote on proposals for the distribution of funds within the DAO for charitable, or other purposes. A voting software may also be used to control certain funds, which may belong to the DAO.

Blocks may be validated at consistent time intervals. During the time intervals, block validators may stake coins, where the total staked coins are aggregated for each block along with a Boolean vote.

s∈S|p=sₙ/S (1)

v∈V|vₙ=0;vᵢ=1 (2)

Equation 1 defines the staking mechanism to ensure voting is proportional. Equation 2 defines the general variables for voters as a collection of votes. Upon the time interval collapsing, the total coins staked will be summed, along with the total positive votes.

In certain embodiments, a general-purpose voting algorithm may be defined. Equation 3 is a summation for positive votes. Equation 4 calculates whether a majority consensus has been reached as an average of the positive votes and total votes.

T=Σ_{V}_{ᵢ}V (3)

M=T/V (4)

The total positive votes will be divided by the total votes, if the product M surpasses a consensus majority, the block is validated, and rewards are returned to the validators.

In certain embodiments, embodiments of the present disclosure, a voting population provides user information including votes 200, where the data is transmitted to the blockchain 201 and encrypted as a post-quantum hash. Then, the user assigns digital assets to vote 302, such as Choice, and the digital asset is transferred to an address on the blockchain 303. The voter then allocates one Choice toward vote 404 and the vote recorded and stored on the Algorand blockchain 405.

In certain embodiments of the present disclosure, a user accesses a secure voting interface 300, where the blockchain returns options to users through web portal 202 and the voters of the population allocate one Choice toward vote 203. The voter 100 then allocates one Choice toward vote 404 and the vote recorded and stored on the Algorand blockchain 405. The address on the blockchain aggregates votes 304 and the results are recorded based on the number of assets at each address for each option 305.

In certain embodiments of the present disclosure, voters 100 are able to vote with Choice using as many Choice as they own. Each vote then is sent to a specific address associated with an option associated with a decision. In such embodiments, voters may connect their Algorand wallet to a dApp and then send Choice from their wallet to a vote associated address for a real vote 302. In certain embodiments, users may receive rewards for voting in the form of more Choice.

In certain embodiments of the present disclosure, voters 100 are able to vote with Choice using as many Choice as they own. Each vote then is sent to a specific address associated with an option associated with a decision. In such embodiments, voters may connect their Algorand wallet to an Internet based dApp 202 and then send Choice from their wallet to a vote associated address for a real vote 302. In certain embodiments, the Choice may be stored in the assigned address until the results are complete. Then, an artificial intelligence software program may return all Choice to the voters in addition to rewards for voting in the form of more Choice.

In certain embodiments of the present disclosure, takes the form of a computing device for blockchain vote processing. In such embodiments, the computing device includes at least one processor and at least one memory device where the processor is configured to store user input via a user interface and receive vote data using a first artificial intelligence computer program. Additionally, the artificial intelligence computer program may transform smart contract data using a second artificial intelligence program, which stores the data as a smart contract in a blockchain structure.

In certain embodiments of the present disclosure, the present disclosure is a method for voting where the method performed by a decentralized distribution device. In such embodiments, the decentralized distribution device uses a blockchain technology software, to receive votes from voters 301, where the voting data flows through a quantum secure protocol 104. Then, the decentralized distribution device moves the data to an artificial intelligence computer program, which aggregates and validates data from all voters 401. Finally, the artificial program generates results by calculating votes from two or more decentralized addresses using a second artificial intelligence program and records the results through a secure voter interface 305.

It is to be understood that while certain embodiments and examples of the invention are illustrated herein, the invention is not limited to the specific embodiments or forms described and set forth herein. It will be apparent to those skilled in the art that various changes and substitutions may be made without departing from the scope or spirit of the invention and the invention is not considered to be limited to what is shown and described in the specification and the embodiments and examples that are set forth therein. Moreover, several details describing structures and processes that are well-known to those skilled in the art and often associated with blockchain technologies are not set forth in the following description to better focus on the various embodiments and novel features of the disclosure of the present invention. One skilled in the art would readily appreciate that such structures and processes are at least inherently in the invention and in the specific embodiments and examples set forth herein.

One skilled in the art will readily appreciate that the present invention is well adapted to carry out the objectives and obtain the ends and advantages mentioned herein as well as those that are inherent in the invention and in the specific embodiments and examples set forth herein. The embodiments, examples, methods, and compositions described or set forth herein are representative of certain preferred embodiments and are intended to be exemplary and not limitations on the scope of the invention. Those skilled in the art will understand that changes to the embodiments, examples, methods and uses set forth herein may be made that will still be encompassed within the scope and spirit of the invention. Indeed, various embodiments and modifications of the described compositions and methods herein which are obvious to those skilled in the art, are intended to be within the scope of the invention disclosed herein. Moreover, although the embodiments of the present invention are described in reference to use in connection with blockchain technology, ones of ordinary skill in the art will understand that the principles of the present inventions could be applied to other types of computers for a wide variety of applications.

We claim:

1. A computing device for blockchain vote processing, the computing device comprising at least one processor and at least one memory device, the processor configured to: store, in a database using computing resources, user input data input via a user interface; receive vote data using a first artificial intelligence computer program based on the user input data stored in the database; and transform smart contract data using a second artificial intelligence program to store the data as a smart contract in a blockchain structure.

2. The computing device of claim 1, wherein the first artificial intelligence computer program is a neural network, cleaning data and storing the data in the database.

3. The computing device of claim 1, wherein the first artificial intelligence computer program is an embedded intelligence, cleaning data and storing the data in the database.

4. The computing device of claim 1, wherein the blockchain structure is the Algorand Network.

5. The computing device of claim 1, wherein the blockchain structure is a proof-of-stake blockchain.

6. The computing device of claim 1, wherein the blockchain structure is a proof-of-work blockchain.

7. A method for voting, the method performed by a server computing device, the method comprising: causing, by the server computing device, at least one client computing device to generate at least one voter interface; receiving, by the server computing device, votes via the at least one voter interface according to a quantum secure protocol; aggregating, by the server computing device, data from all voters using an artificial intelligence computer program to generate a result; storing, by the server computing device, the result in as a smart contract in a blockchain structure; and causing, by the server computing device, the at least one voter interface to display the result.

8. The method of claim 7, wherein the artificial intelligence computer program is a neural network configured to aggregate data received from the at least one client computing device via cloud computing resources.

9. The method of claim 7, wherein the artificial intelligence computer program is an embedded intelligence configured to aggregate data received from the at least one client computing device via cloud computing resources.

10. The method of claim 7, further comprising processing, by the server computing device, the received votes under the quantum secure protocol.

11. The method of claim 7, wherein the quantum secure protocol uses a SHA-512 algorithm to encrypt and secure voter information.

12. The method of claim 7, wherein the artificial intelligence computer program includes a reinforcement learning computer program and a neural network computer program.

13. The method of claim 7, wherein the smart contract is an Algogeneous smart contract.

14. The method of claim 7, wherein the smart contract is configured to receive and aggregate the votes according to logical rules.

15. The method of claim 7, wherein the artificial intelligence computer program is an actor-critic neural network, and wherein the server computing device includes a quantum computer.

16. A method for voting, the method performed by a decentralized distribution device, including one or more processors and one or more memory devices, using a blockchain technology software, receiving by the decentralized distribution device, votes from voters, the votes flowing through a quantum secure protocol, securing a network, and moving the data to an artificial intelligence computer program, aggregating data from all voters, generating results by a processor, calculating votes from two or more decentralized addresses using a second artificial intelligence program, recording the results by the second artificial intelligence program, and reporting the results to the voters through a secure voter interface.

17. The method of claim 16, wherein the second artificial intelligence computer program is an embedded intelligence.

18. The method of claim 16, wherein the blockchain technology software is the Algorand blockchain.

19. The method of claim 16, wherein the blockchain technology software is the Bitcoin blockchain.

20. The method of claim 16, wherein the blockchain technology software is the Ethereum blockchain.
